(19) United States
(12) Patent Application Publication
(10) Pub. No.: US 2013/0045040 A1
(43) Pub. Date: Feb. 21, 2013

(54) Pin Joint Having an Elastomeric Bushing

(71) Applicants: Ronald Mark Ginn, Morton, IL (US); Dan J. Becker, Peoria, IL (US); Sunil I. Mathew, Peoria, IL (US); David G. Kupper, Edelstein, IL (US)

(72) Inventors: Ronald Mark Ginn, Morton, IL (US); Dan J. Becker, Peoria, IL (US); Sunil I. Mathew, Peoria, IL (US); David G. Kupper, Edelstein, IL (US)

(73) Assignee: CATERPILLAR INC., Peoria, IL (US)

(21) Appl. No.: 13/589,848

(22) Filed: Aug. 20, 2012

Related U.S. Application Data
(60) Provisional application No. 61/525,014, filed on Aug. 18, 2011.

(51) Int. Cl. F16C 11/04

(52) U.S. Cl. 403/26

(57) ABSTRACT

An elastomeric bushing can be incorporated into a pin joint assembly of a machine. The elastomeric bushing can be configured to allow at least three degrees of relative rotational movement, including roll, pitch, and yaw. The elastomeric bushing can rotate with respect to a pin about a longitudinal axis thereof. The elastomeric bushing is adapted to accommodate out-of-plane movement. The elastomeric bushing can include a plurality of alternating elastomeric layers and metal plies.

### CROSS-REFERENCE TO RELATED APPLICATIONS

This patent application claims the benefit of priority to U.S. Provisional Patent Application No. 61/525,014, filed on Aug. 18, 2011, and entitled “Elastomeric Bearing for Equalizer Bar of Undercarriage,” which is incorporated in its entirety herein by this reference.

### TECHNICAL FIELD

This patent disclosure relates generally to a pin joint and, more particularly, to a pin cartridge including an elastomeric bearing.

### BACKGROUND

Pin joints are employed on many types of residential and industrial machinery and equipment to provide, for instance, pivot points between adjoining components. Most pin joints include various assemblies and structures intended to help prevent premature breakage or wear, such as, components that define chambers for holding lubricant, for example. However, pin joints can be used to support extreme radial and axial loads which cause high mechanical and thermal stress and strain of pin joint assemblies. Such stress and strain not only can cause component breakage and wear, but also can cause leakage or release of lubricant, which in turn can lead to further component breakage and wear as well as environmental pollution. This occurrence has become so frequent that some machinery and equipment are designed to regularly pump fresh lubricant into pin joints in order to replace continually-leaking lubricant. As demands on pin joint assemblies increase in succeeding generations of machinery and equipment, more robust pin joint assembly designs are highly desirable. For example, it would be helpful to have a pin joint that can oscillate about one axis and be able to accommodate out-of-plane motion.

Commonly-owned U.S. Pat. No. 7,309,186 to Oertley (“the '186 patent”), is entitled, “Pin Cartridge for a Pin Joint.” Specifically, the '186 patent describes a pin cartridge assembly that includes a pin, a bushing, a collar at each end of the pin, and a sleeve bearing between each end of the bushing and the pin. Two-element seals known to those of ordinary skill in the art as “can and lip” seals help retain lubricant in the pin cartridge.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure describes embodiments of a pin joint assembly. In one embodiment, a pin joint assembly includes an elastomeric bushing and a pin. The elastomeric bushing defines an axial passage extending therethrough along a longitudinal axis. The pin is disposed in the axial passage of the elastomeric bearing and extends along the longitudinal axis. The elastomeric bushing includes an inner race extending along the longitudinal axis and an outer race coaxially arranged with the inner race. The inner race is rotationally movable with respect to the pin about the longitudinal axis. At least one elastomeric layer is disposed between the outer race and the inner race. The outer race is pivotably movable with respect to the inner race about at least one axis substantially perpendicular to the longitudinal axis.

In another embodiment, a machine includes a frame, a pivotal member, and a pin joint assembly. The pivotal member is pivotally attached to the frame via the pin joint. The pin joint assembly includes an elastomeric bushing and a pin. The elastomeric bushing defines an axial passage extending therethrough along a longitudinal axis. The elastomeric bushing is coupled to the pivotal member. The pin is disposed in the axial passage of the elastomeric bearing and extends along the longitudinal axis. The pin is coupled to the frame. The elastomeric bushing includes an inner race extending along the longitudinal axis and an outer race coaxially arranged with the inner race. The inner race is rotationally movable with respect to the pin about the longitudinal axis. At least one elastomeric layer is disposed between the outer race and the inner race. The outer race is pivotably movable with respect to the inner race about at least one axis substantially perpendicular to the longitudinal axis.

Further and alternative aspects and features of the disclosed principles will be appreciated from the following detailed description and the accompanying drawings. As will be appreciated, the principles related to elastomeric bushings for a pin joint, pin joints, and machines disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a diagrammatic side elevational view of an embodiment of a machine featuring a lift arm assembly including an embodiment of a pin joint constructed in accordance with principles of the present disclosure.

FIG. 2 is a cross-sectional view of the pin joint taken along line II-II in FIG. 1.

FIG. 3 is an enlarged detail view of a seal assembly within the pin joint assembly, which is taken around line III-III in FIG. 2.

FIG. 4 is a diagrammatic elevational view, partially in section, of another embodiment of a pin joint constructed in accordance with principles of the present disclosure.

FIG. 5 is a perspective view, in section, of an embodiment of a split-spherical elastomeric bushing in accordance with principles of the present disclosure, showing the elastomeric bushing in an unassembled condition.

FIG. 6 is an enlarged, detail view of the elastomeric bushing of FIG. 5.

FIG. 7 is a view of the elastomeric bushing as in FIG. 5, but showing the elastomeric bushing in an assembled condition.

### DETAILED DESCRIPTION

The present disclosure provides embodiments of a pin joint having an elastomeric bushing, which can be used in a machine. Examples of such machines include machines used for construction, compaction, mining, farming, transportation, forestry, and other similar industries.

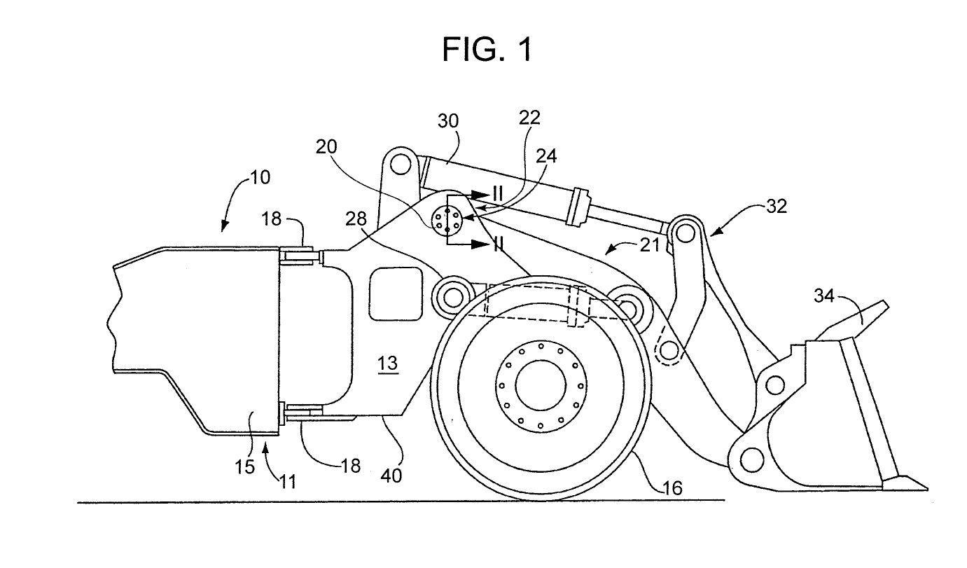

Referring now to the drawings, and in particular to FIG. 1, a machine 10 in the form of a wheel loader is shown. It should be understood, however, that in other embodiments, many other types of machines that include pivotal linkage arrangements, such as dozers, backhoes, excavators, material handlers and the like, can utilize a pin joint constructed in accordance with principles of the present disclosure.

The machine 10 has a frame 11 with a front or non-engine end portion 13 and a rear or engine end portion 15. A plurality of ground-engaging members 16 (e.g., wheels, tracks, etc.) one of which is shown, can be connected to the front portion 13 and the rear portion 15 of the frame 11 through axles, drive shafts or other components (not shown).

A hitch arrangement pivotally connects the front portion 13 to the rear portion 15 by way of a pair of hinge joints 18. The rear or engine end portion 15 of the frame 11 can support, for example, a power source and cooling system components (not shown), the power source being operatively connected through a drive train (not shown) to drive at least one ground-engaging member 16 (such as, a plurality of wheels, as shown) for movement of the machine 10.

The front portion 13 of the frame 11 has a first member 20 engaged therewith, such as by frame members or flanges in spaced relationship to each other, for example. A pivotal member 21, in the form of a lift arm assembly or boom, for example, has a second member 22 engaged therewith and is pivotally connected to the front portion 13 of the frame 11 by a pin joint assembly 24. The pin joint assembly 24 is used to pivotally mount the lift arm assembly or boom 21 to the front portion 13 of the frame 11. The first member 20 and the second member 22 can be part of the pin joint assembly 24.

A lift cylinder 28 is pivotally connected between the front portion 13 of the frame 11 and the lift arm assembly or boom 21. A tilt cylinder 30 is connected between the front portion 13 and a linkage arrangement 32. The boom 21, the lift cylinder 28, the tilt cylinder 30 and the linkage arrangement 32 can raise, lower and angle an attached implement 34, such as a bucket, during loading and unloading operations, for example.

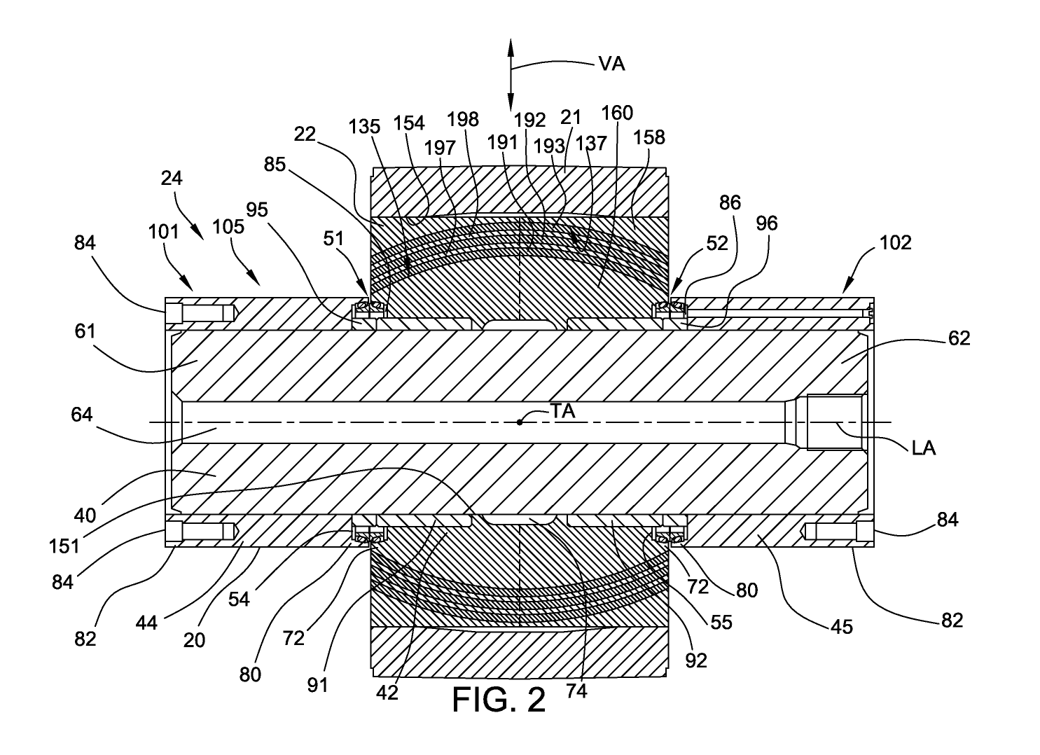

Referring to FIG. 2, the pin joint assembly 24 includes a pin 40 extending through an elastomeric bushing 42 and first and second collars 44, 45. The pin 40 defines a longitudinal axis “LA.” The elastomeric bushing 42 is intermediately disposed along the longitudinal axis “LA” between the first and second collars 44, 45. First and second seal assemblies 51, 52 are disposed in axially-extending first and second seal cavities 54, 55 between the first collar 44 and the elastomeric bushing 42 and the elastomeric bushing 42 and the second collar 45, respectively. The first and second collars 44, 45 are mounted to the pin 40 such that they are secured together to prevent relative movement therebetween. The elastomeric bushing 42 is rotatable about the longitudinal axis “LA” relative to the pin 40 and the first and second collars 44, 45 with the first and second seal assemblies 51, 52 respectively providing running seals therebetween.

In some embodiments, the first member 20 can comprise the first collar 44 and the second member 22 can comprise the elastomeric bushing 42 which are both coaxial with the pin 40 about the longitudinal axis “LA.” The second member 22 in the form of the elastomeric bushing 42 is pivotable about the longitudinal axis “LA” with respect to the first member 20 in the form of the first collar 44 and with respect to the pin 40. It should be understood, however, that the use of the terms “first,” “second,” and the like herein is for convenient reference only and is not limiting in any way.

The pin 40 includes opposing first and second end portions 61, 62. The pin 40 includes an axial bore 64 coaxially arranged with the longitudinal axis “LA.” The axial bore 64 can be sized to accommodate a mounting element (not shown) therethrough, such as a draw bolt, for example.

The elastomeric bushing 42 includes opposing first and second end portions 71, 72. The elastomeric bushing 42 is coaxial with the pin 40 about the longitudinal axis “LA.” The elastomeric bushing 42 defines a substantially centrally disposed cavity 74 for receiving lubricant (not shown). The cavity 74 is adapted to be filled with oil for lubricating the rotating interfaces of the pin joint assembly 24.

Referring to FIG. 2, the first and second collars 44, 45 respectively engage the first and second end portions 61, 62 of the pin 40 and are rotatively coupled with the pin 40. The first and second collars 44, 45 can be secured to the pin 40 by any suitable technique, such as by being respectively press fit on the first and second end portions 61, 62 of the pin 40 and being retained there by welding or other suitable manner. The first and second collars 44, 45 are coaxial with the pin 40 about the longitudinal axis “LA.” The first and second collars 44, 45 each have an inner portion 80 and an outer portion 82. The inner portion 80 of the first collar 44 and the inner portion 80 of the second collar 45 are respectively oriented in proximal relation to the first and second end portions 71, 72 of the elastomeric bushing 42. The outer portions 82 of the first and second collars 44, 45 are respectively oriented in outward distal relation to the first and second end portions 71, 72 of the elastomeric bushing 42.

Any suitable technique can be used to secure the first and second collars 44, 45 and/or the pin 40 to the front portion 13 of the frame 11. In the illustrated embodiment, the outer portions 82 of the first and second collars 44, 45 each includes a plurality of mounting holes 84 therein. The mounting holes 84 are each adapted to threadingly receive a mounting fastener (not shown). The mounting fasteners can be used to secure the first and second collars 44, 45 to a respective structural element of the front portion 13 of the frame 11. In some embodiments, the structural element can comprise a wall member of the front portion 13, inserts adapted to retentively engage a wall member of the front portion 13, a retaining plate, or the like. The structural elements can be further secured via shims and welds to the front portion 13 of the frame 11 to help connect the first and second collars 44, 45 and/or the pin 40 to the front portion 13 of the frame 11.

The first end portion 71 of the elastomeric bushing 42, the inner portion 80 of the first collar 44, and the pin 40 cooperate to define the first seal cavity 54 and a substantially annular first channel 85 for receiving lubricant (not shown). Similarly, the second end portion 72 of the elastomeric bushing 42, the inner portion 80 of the second collar 45, and the pin 40 cooperate to define the second seal cavity 55 and a substantially annular second channel 86, also for receiving lubricant (not shown).

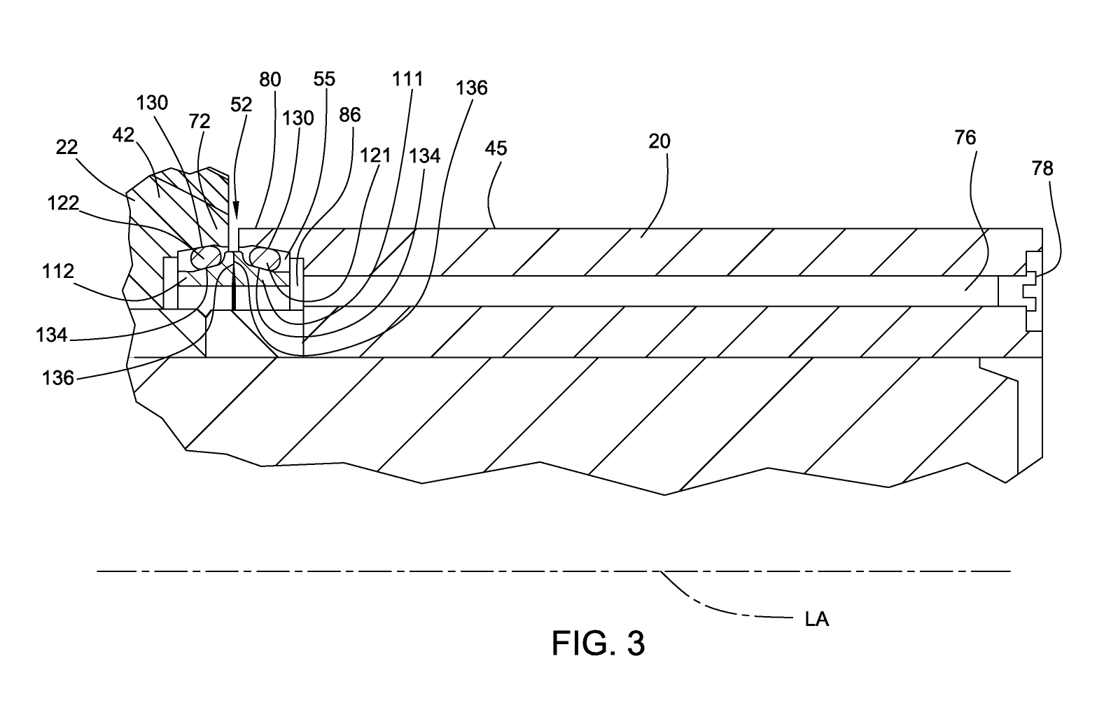

The first and second annular channels 85, 86 can be in fluid communication with the cavity 74 defined between the elastomeric bushing 42 and the pin 40 to facilitate the introduction of lubricant into the first and second channels 85, 86 and the cavity 74. In this regard, a threaded opening 76 (see FIG. 3) is provided in at least one of the first and second collars 44, 45 and is plugged with a removable threaded plug 78 to allow lubricant to be added to the first and second channels 85, 86 and the cavity 74.

Referring to FIG. 2, first and second annular sleeve bearings 91, 92 can be respectively provided in the first and second annular channels 85, 86. The first and second annular sleeve bearings 91, 92 are coaxial with the pin 40 about the longitudinal axis “LA.” The first and second sleeve bearings 91, 92 engage the pin 40 and are disposed in respective underlying relation to, and respectively engage, the first and second end portions 71, 72 of the elastomeric bushing 42.

First and second thrust rings 95, 96 can be provided in the first and second annular channels 85, 86, respectively. The first and second thrust rings 95, 96 are coaxial with the pin 40 about the longitudinal axis “LA.” The thrust rings 95, 96 are oriented in spaced-apart relation relative to the elastomeric bushing 42.

The first thrust ring 95 is disposed around the pin 40 between the inner portion 80 of the first collar 44 and the first sleeve bearing 91. The second thrust ring 96 is disposed around the pin 40 between the inner portion 80 of the second collar 45 and the second sleeve bearing 92. The first and second thrust rings 95, 96 can intermittently or continuously engage the first and second sleeve bearings 91, 92, respectively, during use of the pin joint assembly 24.

The first and second seal assemblies 51, 52 are respectively disposed in the first and second seal cavities 54, 55 and are coaxial with the pin 40 about the longitudinal axis “LA.” The first and second seal assemblies 51, 52 allow the elastomeric bushing 42 to rotate with respect to the first and second collars 44, 45 and to maintain a sealing relationship between the first and second collars 44, 45 and the elastomeric bushing 42 such that the first and second annular channels 85, 86 and the cavity 74 for receiving lubricant can substantially retain lubricant housed therein. The illustrated first and second seal assemblies 51, 52 comprise metal-to-metal face seal assemblies. In other embodiments, other suitable seal assemblies can be used.

The first collar 44, the first thrust ring 95, the first sleeve bearing 91, and the first seal assembly 51 comprise a first subassembly 101 of the pin joint assembly 24. The second collar 45, the second thrust ring 96, the second sleeve bearing 92, and the second seal assembly 52 comprise a second subassembly 102 of the pin joint assembly 24.

The first and second seal assemblies 51, 52 are substantially identical to each other. Furthermore, the first and second subassemblies 101, 102 are substantially identical to each other. It should be understood, therefore, that the description of one seal assembly is applicable to the other seal assembly and the description of one subassembly is applicable to the other subassembly, as well.

Referring to FIG. 2, the pin joint assembly 24—including the pin 40, the elastomeric bushing 42, and the subassemblies 101, 102—can be provided in a unitary cartridge 105 in order to ease maintenance and/or replacement of the pin joint assembly 24.

In other embodiments, such as in those situations where the application and environment in which the pin joint assembly is employed so warrant, the pin joint assembly 24 can include only one of the subassemblies 101, 102, in which case only the corresponding end portion of the pin 40 and end portion of the elastomeric bushing 42 may be provided with a subassembly—that is, a collar, a thrust ring, a sleeve bearing, and a seal assembly. In such instances, the opposing end portion of the pin 40, and the corresponding end portion of the elastomeric bushing 42 in proximal relation thereto which are not provided with all elements of a subassembly, may be provided with no elements of a subassembly or some elements of a subassembly. For instance, by way of example and not by way of limitation, in one embodiment, the first end portion 61 of the pin 40 and the first end portion 71 of the elastomeric bushing 42 are provided with the first subassembly 101, and the second end portion 62 of the pin 40 and the second end portion 72 of the elastomeric bushing 42 are provided with only the second sleeve bearing 92 and the second seal assembly 52, thereby omitting the second collar 45 and the second thrust ring 96.

Referring to FIG. 3, the second seal assembly 52 is disposed in the second seal cavity 55 between an example of a “first member” in the form of the second collar 45 and the “second member” 22 in the form of the elastomeric bushing 42. The second seal assembly 52 includes first and second annular seal rings 111, 112 and first and second gaskets or annular load rings 121, 122. The first and second seal rings 111, 112 of the second seal assembly 52 are disposed in abutting relationship with each other. The first and second load rings 121, 122 are respectively mounted to the first and second seal rings 111, 112. The first and second seal rings 111, 112 can be made from any suitable metal. The first and second load rings 121, 122 are preferably made from a suitable elastomeric material.

In the second seal assembly 52, the first load ring 121 acts as a gasket and sealingly engages the second collar 45 and the first seal ring 111. The second load ring 122 acts as a gasket and sealingly engages the elastomeric bushing 42 and the second seal ring 112. As will be understood, therefore, in the first seal assembly 51, the first load ring 121 sealingly engages the first collar 44 and the first seal ring 111, and the second load ring 122 sealingly engages the elastomeric bushing 42 and the second seal ring 112.

The inner portion 80 of the second collar 45 is in proximal relation to the second end portion 72 of the elastomeric bushing 42. The inner portion 80 of the second collar 45 and the second end portion 72 of the elastomeric bushing 42 each includes a load ring engagement surface 130. The load ring engagement surfaces 130 are generally annular and are coaxial with the longitudinal axis “LA.” The load ring engagement surfaces 130 of the “first member” in the form of the second collar 45 and the “second member” in the form of the elastomeric bushing 42 define, at least in part, the axially-extending second seal cavity 55 interposed between the first member 20 and the second member 22. It will be understood that the first end portion 71 of the elastomeric bushing 42 cooperates with the first collar 44 in a similar manner to define, at least in part, the axially-extending first seal cavity 54 interposed between the elastomeric bushing 42 and the first collar 44.

The first and second seal rings 111, 112 are substantially identical to each other and are each in the form of an annulus. The first and second seal rings 111, 112 each have an axially-extending ramped loading surface 134 and a radially-extending sealing face 136. The annular, radially-extending sealing faces 136 of the first and second seal rings 111, 112 are in opposing relationship with each. The first and second seal rings 111, 112 abut one another such that the sealing faces 136 of the first and second seal rings 111, 112 are in sealing, contacting relationship with each other.

The first and second load rings 121, 122 are substantially identical to each other. The first and second load rings 121, 122 each has a generally circular cross-sectional shape when in an unloaded condition with a predetermined radius.

The first load ring 121 engages the load ring engagement surface 130 of the second collar 45 and the loading surface 134 of the first seal ring 111. The second load ring 122 engages the load ring engagement surface 130 of the elastomeric bushing 42 and the loading surface 134 of the second seal ring 112. The first and second load rings 121, 122 are positioned such that they drive the sealing faces 136 of the first and second seal rings 111, 112 together to define a band of contact therebetween. The load rings 121, 122 act in the manner of a spring to apply an axial load respectively against the first and second seal rings 111, 112 in opposing directions along the longitudinal axis “LA” to bring the sealing faces 136 of the first and second seal rings 111, 112 into face-to-face sealing contact under pressure along the band of contact such that a running, fluid-tight seal is formed.

The first and second seal rings 111, 112 are rotationally movable with respect to each other about the longitudinal axis “LA.” In this arrangement, the first seal ring 111 can be considered a stationary seal ring as it is rotatively coupled with the second collar 45. The second seal ring 112 can be considered a rotational seal ring as it is coupled with the elastomeric bushing 42 and can rotate relative to the second collar 45 and to the pin 40.

Referring to FIG. 2, the elastomeric bushing 42 defines an axial passage 151 therethrough along the longitudinal axis “LA.” The pin 40 is disposed in the axial passage 151 of the elastomeric bushing 42 and extends along the longitudinal axis “LA” through the elastomeric bushing 42. The boom 21 defines a through passage 154, which is adapted to receive the elastomeric bushing 42 therethrough. The elastomeric bushing 42 is preferably adapted to accommodate a certain degree of misalignment and/or have self-aligning properties. The elastomeric bushing 42 can be held in place in the through passage 154 of the boom 21 via any suitable means, such as a snap ring and groove arrangement and/or a press-fit arrangement, for example.

The elastomeric bushing 42 in this embodiment has an outer race 158 and an inner race 160 which are arranged such that the outer race 158 can rotate and swivel relative to the inner race 160. The outer race 158 and the inner race 160 are generally cylindrical and coaxially disposed with respect to each other and the longitudinal axis “LA.” The inner race 160 extends along the longitudinal axis “LA,” and is rotationally movable with respect to the pin 40 about the longitudinal axis “LA.” The outer race 158 is pivotably movable with respect to the inner race 160 about at least one axis substantially perpendicular to the longitudinal axis “LA.”

In embodiments, at least one elastomeric layer is disposed between the outer race 158 and the inner race 160. The illustrated elastomeric bushing 42 includes a plurality of alternating elastomeric layers 191, 192, 193 and metal plies 197, 198 disposed between the outer race 158 and the inner race 160. In the illustrated embodiment, the elastomeric bushing 42 includes three elastomeric layers 191, 192, 193 with two metal plies 197, 198 interposed therebetween such that each of the elastomeric layers 191, 192, 193 is separated from each adjacent elastomeric layer by an intervening metal ply 197, 198.

Each metal ply 197, 198 preferably comprises steel or another suitable material capable of withstanding the load and stresses applied to the elastomeric bushing 42 during normal operating conditions involved with any particular work machine application. Each elastomeric layer 191, 192, 193 preferably comprises any suitable resilient material capable of withstanding the particular loads involved with any particular work machine application, and preferably absorbs and/or dampens a portion of the load applied thereto. The outer and inner races 158, 160 preferably comprise steel or another suitable material capable of withstanding the load and stresses applied to the elastomeric bushing 42 during normal operating conditions involved with any particular work machine application.

The illustrated elastomeric layers 191, 192, 193 and metal plies 197, 198 have an arcuate shape in cross-section and are generally barrel-shaped. Adjoining elastomeric layers 191, 192, 193 and metal plies 197, 198 can have a complementary radius of curvature. An outer surface 135 of the inner race 160 can have a complementary radius of curvature as the innermost elastomeric layer 191. An inner surface 137 of the outer race 158 can have a complementary radius of curvature as the outermost elastomeric layer 193. The elastomeric layers 191, 192, 193 and metal plies 197, 198 can have a curvature to help accommodate the relative rotational motion therebetween as either “pitch” or “yaw” as described below.

In other embodiments, the elastomeric bushing can have a different number of elastomeric layers and metal plies. For example, in some embodiments, the elastomeric bushing can have a single elastomeric layer; in other embodiments, the elastomeric bushing can include a pair of elastomeric layers separated by a single metal ply; and in still other embodiments, the elastomeric bushing can include four or more elastomeric layers separated by three or more metal plies.

The outer race 158 is in engaging contact with the boom 21 such that the outer race 158 and the boom 21 are coupled together to prevent relative movement therebetween. The inner race 160 is adapted to rotate with respect to the pin 40 about the longitudinal axis “LA.”

The elastomeric bushing 42 is coaxially disposed with respect to the pin 40 such that they both extend along the longitudinal axis “LA.” The pin 40 is configured such that the pin 40 extends a predetermined length along the longitudinal axis “LA” that is greater than the length of the axial passage 151 of the elastomeric bushing 42 so that first and second end portions 61, 62 of the pin 40 project from the first and second end portions 71, 72, respectively, of the elastomeric bushing 42. In other embodiments, a portion of the pin 40 can project from only one of the first and second end portions 71, 72 of the elastomeric bushing 42.

The elastomeric bushing 42 permits the boom 21 and the pin 40 (and, thus, the first and second collars 44, 45 and the front portion 13 of the frame 11) to undergo relative rotation and translation. The boom 21 and the pin 40 (and, thus, the first and second collars 44, 45 and the front portion 13 of the frame 11) can undergo relative rotation through the elastomeric bushing 42 with at least three degrees of rotational freedom to allow relative movement referred to as roll, pitch, and yaw. “Roll” is rotational movement about the longitudinal axis “LA.” “Pitch” in this context may be described as relative rotation in a generally vertical plane where the vertical plane is defined by the longitudinal axis “LA” and a vertical axis “VA,” which is perpendicular to the longitudinal axis “LA.” When the elastomeric bushing 42 undergoes relative rotation referred to as pitch, the components of the elastomeric bushing 42 can move relative to each other about a transverse axis “TA,” which is perpendicular to both the longitudinal axis “LA” and the vertical axis “VA,” to accommodate out-of-plane movement of the boom 21. “Yaw” is similar to pitch but takes place in a generally horizontal plane where the horizontal plane is defined by the longitudinal axis “LA” and the transverse axis “TA.” When the elastomeric bushing 42 undergoes relative rotation referred to as yaw, the components of the elastomeric bearing can move relative to each other about the vertical axis “VA.” The elastomeric bushing 42 can be adapted to allow two or more of these types of relative rotation to occur simultaneously. In some embodiments, the three rotational degrees of freedom may be combined or limited in any suitable manner. In some embodiments, the outer race 158 and the inner race 160 are pivotably movable with respect to each other with at least two degrees of freedom.

To help reduce elastomeric strains at the edges of the elastomeric bushing 42 when undergoing relative rotation as pitch about the transverse axis “TA,” the elastomeric bushing 42 can include a generally spherical segment configuration. The arrangement of the elastomeric layers 191, 192, 193 and the metal plies 197, 198 provides a generally spherical segment which can help reduce stresses and strains in the elastomeric layers 191, 192, 193 generated by relative rotation, such as, as pitch or yaw.

The boom 21 and the pin 40 (and, thus, the first and second collars 44, 45 and the front portion 13 of the frame 11) can undergo relative translation along the longitudinal axis “LA,” which can be permitted as a function of the axial stiffness of the elastomeric bushing 42. Similarly, the radial stiffness of the elastomeric bushing 42 can permit relative translation along the transverse axis “TA” and the vertical axis “VA.”

The elastomeric bushing 42 is adapted to permit relative rotation between the elastomeric bushing 42 and the pin 40 about the longitudinal axis “LA” (roll). In embodiments, the relative rotation between the elastomeric bushing 42 and the pin 40 can occur with substantially less (or substantially no) (e.g., less than about))±10° relative rotation occurring between the outer race 158 and the inner race 160 of the elastomeric bushing 42. In some embodiments, the elastomeric bushing 42 can rotate with respect to the pin 40 about the longitudinal axis “LA” (roll) over a range of travel of at least about ±45°, at least about ±60° in other embodiments, at least about ±90° in yet other embodiments, at least about ±120° in still other embodiments, at least about ±180° in yet other embodiments, and at least about ±270° in other embodiments.

The elastomeric bushing 42 is adapted to permit relative rotation and translation between the inner race 160 and the outer race 158. In some embodiments, the outer race 158 and the inner race 160 can pivot with respect to each other about the transverse axis “TA” in the vertical plane (pitch) over a range of travel of at least about ±1.5°, at least about ±2° in still other embodiments, and at least about ±3° in yet other embodiments. In some embodiments, the outer race 158 and the inner race 160 can pivot with respect to each other about the vertical axis “VA” in the horizontal plane (yaw) over a range of travel of at least about ±0.1°, at least about ±0.25° in still other embodiments, and at least about ±0.5° in yet other embodiments. In some embodiments, the outer race 158 and the inner race 160 can pivot with respect to each other about the longitudinal axis “LA” (roll) over a range of travel of at least about ±3.5°, at least about ±4.25° in other embodiments, and at least ±5° in still other embodiments. In other embodiments, the range of travel for one or more degrees of rotational freedom and/or translation between the outer race 158 and the inner race 160 can be varied to accommodate a particular application in which the elastomeric bushing 42 is to be used.

In other embodiments, pin joints in accordance with principles of the present disclosure can include additional and/or different components as are known in the art. For example, in other embodiments, a pin joint assembly can include components, and can be mounted to a frame using connecting elements, as shown and described in U.S. Pat. No. 7,309,186, which is entitled, “Pin Cartridge for a Pin Joint.”

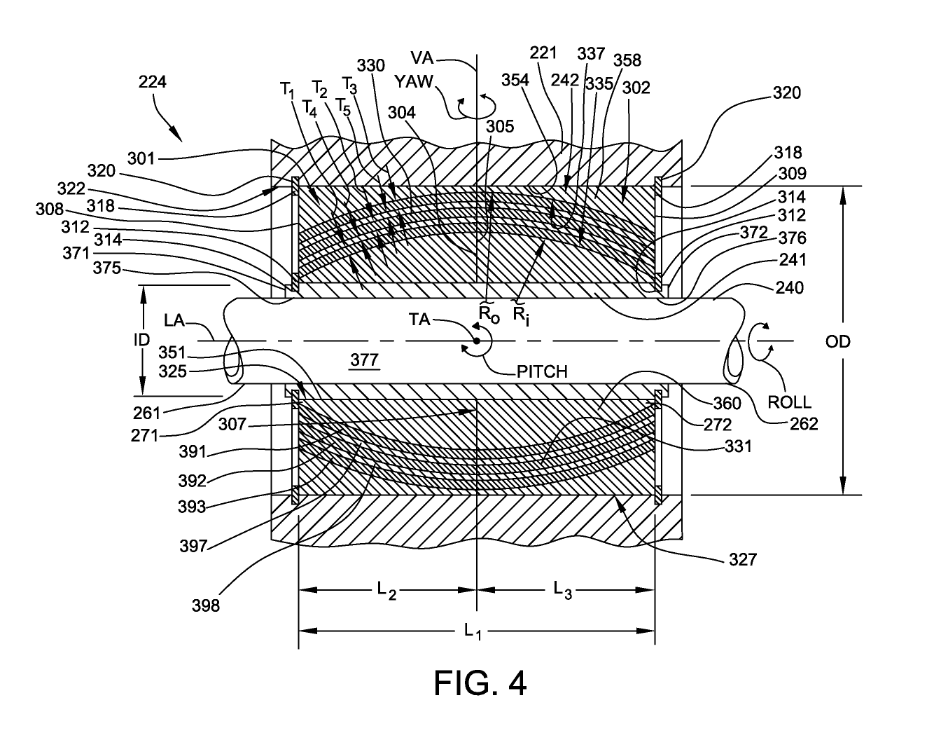

Referring to FIG. 4, another embodiment of a pin joint assembly 224 is shown. The pin joint assembly 224 includes a pin 240 extending through a self-lubricating sleeve bearing 241 and an elastomeric bushing 242. The pin 240 defines a longitudinal axis “LA.” The self-lubricating sleeve bearing 241 and the elastomeric bushing 242 are both generally cylindrical and coaxially disposed with respect to the pin 240 such that they both extend along the longitudinal axis “LA.” The self-lubricating sleeve bearing 241 is coaxially disposed with respect to the elastomeric bushing 242 and the pin 240. The self-lubricating sleeve bearing 241 is radially interposed between the elastomeric bushing 242 and the pin 240.

The self-lubricating sleeve bearing 241 is rotatably movable with respect to the pin 240 about the longitudinal axis “LA.” The self-lubricating sleeve bearing 241 is secured to the inner race 360 of the elastomeric bearing 242, such as by being press fit together, for example, to prevent relative rotation between the inner race 360 and the self-lubricating sleeve bearing 241 about the longitudinal axis “LA.” The elastomeric bushing 242 and the self-lubricating sleeve bearing 241 are rotatable about the longitudinal axis “LA” relative to the pin 240

The self-lubricating sleeve bearing 241 can be any suitable sleeve bearing which is adapted to rotate relative to the pin 240 about the longitudinal axis “LA,” such as one that does not require additional lubricant. An example of a suitable self-lubricating sleeve bearing is one made by Caterpillar Inc. and known by designation “1E1173.” First and second seal assemblies 371, 372 can be respectively provided at first and second end portions 375, 376 of the self-lubricating sleeve bearing 241 to respectively provide running seals between the self-lubricating sleeve bearing 241 and the pin 240. The first and second seal assemblies 371, 372 can be any suitable seal adapted to seal the first and second end portions 375, 376 of the self-lubricating sleeve bearing 241.

The self-lubricating sleeve bearing 241 permits relative rotational movement between the elastomeric bushing 242 and the pin 240 while providing radial load capacity. The self-lubricating sleeve bearing 241 can be adapted to help provide galling resistance without the need for regular maintenance, thereby providing a “maintenance free” pin joint assembly.

The pin 240 can comprise a linkage pin as is known in the art which includes an external surface 377 having a surface treatment and finish that are compatible with the self-lubricating sleeve bearing 241 to promote relative rotation therebetween about the longitudinal axis “LA.” The pin 240 can be configured as a separate part from the other components of the pin joint assembly 224 to facilitate its removal for service.

The elastomeric bushing 242 defines an axial passage 351 therethrough. The pin 240 is disposed in the axial passage 351 of the elastomeric bushing 242 and extends along the longitudinal axis “LA” through the elastomeric bushing 242. A pivotal member 221 (such as, e.g., a boom) defines a through passage 354, which is adapted to receive the elastomeric bushing 242 therethrough. The elastomeric bushing 242 is preferably adapted to accommodate a certain degree of misalignment and/or have self-aligning properties. The elastomeric bushing 242 can be held in place in the through passage 354 of the pivotal member 221 via any suitable means, such as a snap ring and groove arrangement (as shown) and/or a press-fit arrangement, for example. The pin 240 is configured such that the pin 240 extends a predetermined length along the longitudinal axis “LA” that is greater than the length of the axial passage 351 of the elastomeric bushing 242 so that first and second end portions 261, 262 of the pin 240 project from first and second end portions 271, 272, respectively, of the elastomeric bushing 242.

The elastomeric bushing 242 in this embodiment has an outer race 358 and an inner race 360 which are arranged such that the outer race 358 can rotate and swivel relative to the inner race 360. The elastomeric bushing 242 includes the outer race 358, the inner race 360, and a plurality of alternating elastomeric layers 391, 392, 393 and metal plies 397, 398. In the illustrated embodiment, the elastomeric bushing 242 includes three elastomeric layers 391, 392, 393 with two metal plies 397, 398 interposed therebetween such that each of the elastomeric layers 391, 392, 393 is separated from each adjacent elastomeric layer by an intervening metal ply 397, 398.

The elastomeric bushing 242 includes first and second subassemblies 301, 302 with inner ends 304, 305 which are in adjoining relationship at a midline plane 307. The first and second subassemblies 301, 302 cooperate together to define the outer race 358, the inner race 360, and the plurality of alternating elastomeric layers 391, 392, 393 and the metal plies 397, 398. Embodiments of the elastomeric bushing 242 can be split into two or more subassemblies 301, 302 to help reduce the manufacturing costs for the elastomeric bearing. The split bearing design can facilitate the manufacturability of the elastomeric bushing 242 by segmenting the elastomeric bushing 242 into subassemblies 301, 302 with geometric configurations that are more readily manufactured using conventional techniques, such as injection molding, for example. The split bearing design also facilitates the generation of pre-strain loading in the elastomeric bushing 242 as described below. In other embodiments, the elastomeric bushing 242 can comprise a different number of subassemblies 301, 302, which can also vary depending upon the particular application with which a particular bearing is involved.

At each outer end 308, 309 of the first and second subassemblies 301, 302, a sleeve bearing-engaging snap ring 312 which is adapted to be in retentive engagement with the self-lubricating sleeve bearing 241 and is configured to be disposed within a respective groove 314 defined in the self-lubricating sleeve bearing 241. At each outer end 308, 309 of the first and second subassemblies 301, 302, a pivotal member-engaging snap ring 318 which is adapted to be in retentive engagement with the pivotal member 221 and is configured to be disposed within a groove 320 defined in an interior surface 322 of the pivotal member 221 that also defines the through passage 354 in which the elastomeric bushing 242 is disposed. The sleeve bearing-engaging snap rings 312 and the pivotal member-engaging snap rings 318 function to hold the first and second subassemblies 301, 302 in proper operative position with each other such that the inner ends 304, 305 of the first and second subassemblies 301, 302 are in adjoining relationship with each other along the midline plane 307 and a pre-strain load is generated in the elastomeric bushing 242. The sleeve bearing-engaging snap rings 312 and the pivotal member-engaging snap rings 318 also function to help place the elastomeric bushing 242 into engagement with the self-lubricating sleeve bearing 241 and the pivotal member 221. In other embodiments, the pin joint assembly 224 can include other means for bringing the first and second subassemblies 301, 302 together and engaging the self-lubricating sleeve bearing 241 and the pivotal member 221.

The pivotal member 221 and the outer race 358 of the elastomeric bushing 242 are in engaging contact with each other such that the outer race 358 and the pivotal member 221 are coupled together to prevent relative movement therebetween. The engaging contact between the outer race 358 of the elastomeric bushing 242 and the pivotal member 221 can be established via a press-fit arrangement between the interior surface 322 of the pivotal member 221 and an exterior surface 327 of the outer race 358.

In the illustrated embodiment, the elastomeric bushing 242 has a length “L₁,” measured along the longitudinal axis “LA.” In the illustrated embodiment, the lengths “L₂,” “L₃” of the first and second subassemblies 301, 302 are substantially the same. In other embodiments, the lengths “L₂,” “L₃” of the first and second subassemblies 301, 302 can be different. In still other embodiments, the lengths “L₂,” “L₃” of the first and second subassemblies 301, 302 can be different from each other.

In the illustrated embodiment, an interior surface 325 of the inner race 360 defines the axial passage 351 of the elastomeric bushing 242 and is substantially cylindrical. The interior surface 325 of the inner race 360 defines an inner diameter “ID” of the elastomeric bushing 242. In the illustrated embodiment, the exterior surface 327 of the outer race 358 is substantially cylindrical and defines an outer diameter “OD” of the elastomeric bushing 242.

In still other embodiments, the interior surface 325 of the inner race 360 and/or the exterior surface 327 of the outer race 358 can have different shapes, such as oval-shaped, elliptical, etc.

In the illustrated embodiment, each elastomeric layer 391, 392, 393 has a different thickness “T₁,” T₂,” “T₃,” which can be measured along an axis that is perpendicular to both opposing surfaces of the particular elastomeric layer 391, 392, 393 in question, or to tangential axes taken from opposing surfaces in the case where the elastomeric layer 391, 392, 393 in question is arcuate. The thickness “T₁,” T₂,” “T₃” of each elastomeric layer 391, 392, 393 is different from all of the other elastomeric layers 391, 392, 393. In some embodiments, the thickness “T₁,” T₂,” “T₃” of each elastomeric layer 391, 392, 393 can vary such that the first elastomeric layer 391, which is closest to the inner race 360, is thinner than the second and third elastomeric layers 392, 393, and the second elastomeric layer 392 is thinner than the third elastomeric layer 393, which is closest to the outer race 358.

In other embodiments, the elastomeric layers 391, 392, 393 can each have substantially the same thickness “T₁,” T₂,” “T₃.” In other embodiments, the thicknesses “T₁,” T₂,” “T₃” of at least one elastomeric layer 391, 392, 393 can be different from at least one other elastomeric layer 391, 392, 393.

In the illustrated embodiment, the metal plies 397, 398 each have substantially the same thickness “T₄,” “T₅,” which can be measured along an axis that is perpendicular to both opposing surfaces of the particular metal ply 397, 398 in question, or to tangential axes taken from opposing surfaces in the case where the metal ply 397, 398 in question is arcuate.

In other embodiments, the thicknesses “T₄,” “T₅” of at least one metal ply 397, 398 can be different from at least one other metal ply 397, 398. In yet other embodiments where the elastomeric bushing 242 includes three or more metal plies, the thickness “T₄,” “T₅” of each metal ply can be different from all of the other metal plies.

In still other embodiments, the thickness of at least one elastomeric layer 391, 392, 393 can vary along the longitudinal axis “LA” such that the thickness of the particular elastomeric layer 391, 392, 393 is different in at least two points along the longitudinal axis “LA.” In yet other embodiments, the thickness of at least one metal ply 397, 398 can vary along the longitudinal axis “LA” such that the thickness of the particular metal ply 397, 398 is different in at least two points along the longitudinal axis “LA.”

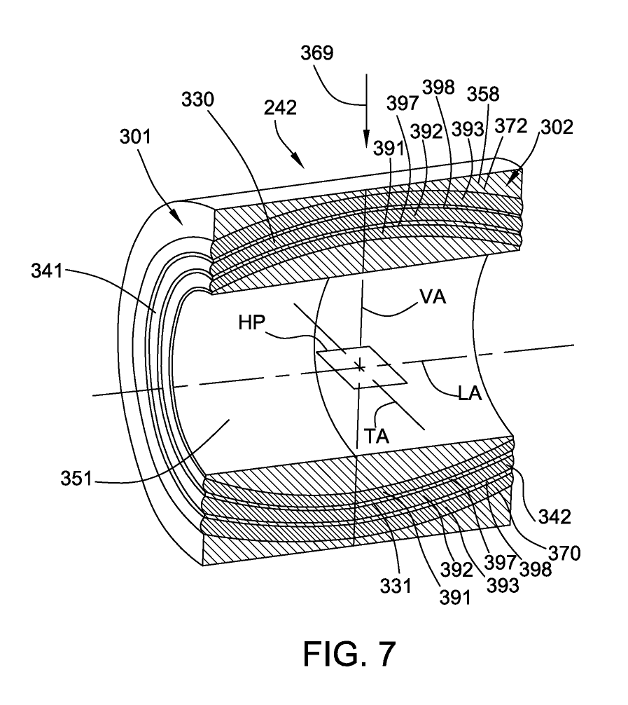

The illustrated elastomeric layers 391, 392, 393 and metal plies 397, 398 have an arcuate shape in cross-section. Adjoining elastomeric layers 391, 392, 393 and metal plies 397, 398 can have a complementary radius of curvature. The elastomeric layers 391, 392, 393 and metal plies 397, 398 can have a curvature to help accommodate the relative rotational motion therebetween as either pitch or yaw. In the illustrated embodiment, the elastomeric layers 391, 392, 393 and the metal plies 397, 398 define a pair of annular arcs 330, 331 in a plane that intersects the longitudinal axis “LA.” The illustrated annular arcs 330, 331 are substantially the same. As such, the following description of one annular arc 330 should be understood to apply to the other annular arc 331, as well. The annular arc 330 is generally circular and includes an inner radius of curvature “Rᵢ” which is greater than an outer radius of curvature “Rₒ” and a central angle “θ” of about 42.5° (see FIG. 7). The various thicknesses “T₁,” T₂,” “T₃” of the elastomeric layers 391, 392, 393 and thicknesses “T₄,” “T₅” of the metal plies 397, 398 define other radii of curvature within the annular arc 330, which can vary depending upon the thicknesses “T₁,” T₂,” “T₃” of the elastomeric layers 391, 392, 393 and the thicknesses “T₄,” “T₅” of the metal plies 397, 398 which comprise the annular arc 330. An exterior surface 335 of the inner race 360 substantially conforms to the inner radius of curvature “Rᵢ” of the annular arc 330. An interior surface 337 of the outer race 358 substantially conforms to the outer radius of curvature “Rₒ” of the annular arc 330.

The illustrated values for the inner radius of curvature “Rᵢ,” the outer radius of curvature “Rₒ,” and the central angle “θ” are exemplary in nature. In other embodiments, at least one of the inner radius of curvature “Rᵢ,” the outer radius of curvature “Rₒ,” and the central angle “θ” can be varied. These parameters can be varied to improve strain characteristics, to meet different load/motion requirements, and/or to accommodate different geometric constraints, for example. As an example, in some embodiments, the inner radius of curvature “Rᵢ” can be decreased and the outer radius of curvature “Rₒ” can be increased. In other embodiments, the outer radius of curvature “Rₒ” can be increased so that it approaches infinity, in other words, substantially no curvature. In still other embodiments, the annular arc 330 can be generally parabolic.

In other embodiments, the elastomeric layers 391, 392, 393 and the metal plies 397, 398 can be different lengths. For example, in some embodiments, the elastomeric bushing 242 can taper, either inwardly or outwardly, as a function of radial distance from the inner diameter “ID” to the outer diameter “OD” of the elastomeric bushing 242.

The multiple elastomeric layers 391, 392, 393 and the metal plies 397, 398 can be provided to help carry the load and accommodate the relative translation and rotational movement of the elastomeric bushing 242 during use of the machine in which it is mounted. In some embodiments, the elastomeric bushing 242 can include at least two elastomeric layers with an intervening metal ply between adjacent elastomeric layers. In still other embodiments, a different number of elastomeric layers and metal plies can be utilized depending upon the particular application involved.

When the elastomeric bushing 242 is subjected to loading conditions, some portion of the elastomeric layers 391, 392, 393 can be placed into tension and another portion into compression. In some cases, the elastomeric portion in tension may be subjected to a state of hydrostatic stress, which can lead to cavitation damage. For example, loading the elastomeric bushing 242 from above along the vertical axis “VA” such that the load is being applied to the outer race 358 in a downward direction 369 can place the elastomeric layers 391, 392, 393 in a lower portion 370 that is disposed below the horizontal plane “HP” in tension and in an upper portion 372 above the central horizontal plane “HP” in compression (see FIG. 7). Furthermore, the elastomeric bushing 242 may be subjected to cyclic loading conditions where loading may vary in magnitude or direction. For example, if the loading is partially or fully reversed (such as when the elastomeric bushing 242 rotates with respect to the pin 240 about the longitudinal axis “LA”), elastomeric portions that had been subjected to tension can be placed into compression and vice versa. Cyclic loading can cause stress or strain cycling in amplitude or direction, which can lead to fatigue damage in the elastomeric layers 391, 392, 393. In some embodiments, the elastomeric layers 391, 392, 393 of the elastomeric bushing 242 can be placed into a pre-compressed state such that any hydrostatic tensile stresses in the elastomeric layers 391, 392, 393 remain below a predetermined level while being subjected to a given load to help reduce cavitation damage. In some embodiments, the elastomeric layers 391, 392, 393 can be placed into a pre-compressed state such that cyclic stress or strain amplitudes in the elastomeric layers 391, 392, 393 remain below a predetermined level while being subjected to a given cyclic loading condition to help reduce fatigue damage.

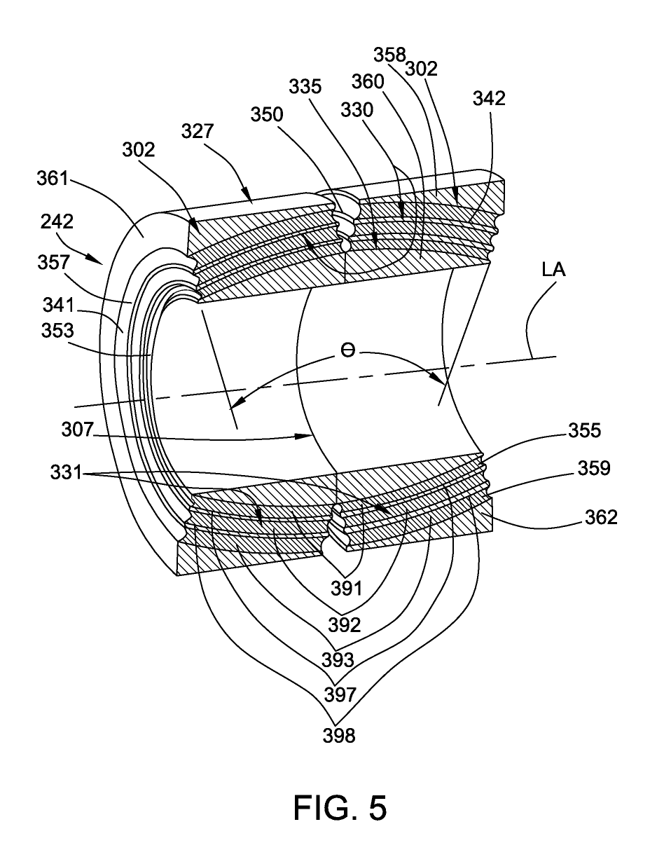

Referring to FIG. 5, the elastomeric bushing 242 is shown in an unassembled state. The first and second subassemblies 301, 302 are disposed in adjoining relationship to each other. The portions 341, 342 of the respective first and second subassemblies 301, 302 that comprise the elastomeric layers 391, 392, 393 and the metal plies 397, 398 are offset from each other at the midline plane 307 along the longitudinal axis “LA” in graduating increments as a function of radial distance from the longitudinal axis “LA.” The offset relationship of the portions 341, 342 of the first and second subassemblies 301, 302 that comprise the elastomeric layers 391, 392, 393 and the metal plies 397, 398 when in the assembled condition define a generally V-shaped circumferential groove 350 about the longitudinal axis “LA” that extends radially from the exterior surface 327 of the outer race 358 to the exterior surface 335 of the inner race 360. The portions 353, 355 of the first and second subassemblies 301, 302 that comprise the first elastomeric layer 391 are closest to each other, and the portions 357, 359 of the first and second subassemblies 301, 302 that comprise the third elastomeric layer 393 are farthest apart from each other.

The elastomeric layers 391, 392, 393 of the elastomeric bushing 242 can be subjected to an axial compressive pre-load by forcing the portions 361, 362 of the first and second subassemblies 301, 302 that comprise the outer race 358 to axially approach each other along the longitudinal axis “LA” to close the V-shaped circumferential groove 350 between the portions 341, 342 of the respective first and second subassemblies 301, 302 that comprise the elastomeric layers 391, 392, 393 and the metal plies 397, 398 (see FIG. 7). The first and second subassemblies 301, 302 can be held in place axially by the sleeve bearing-engaging snap ring 312 and the pivotal member-engaging snap rings 318.

The manufacture and assembly of multiple swaged layers can be a costly process. A bearing joint assembly according to principles of the present disclosure can include a preloaded elastomeric bushing 242 without the need for swaging by using the offset layer configuration described above.

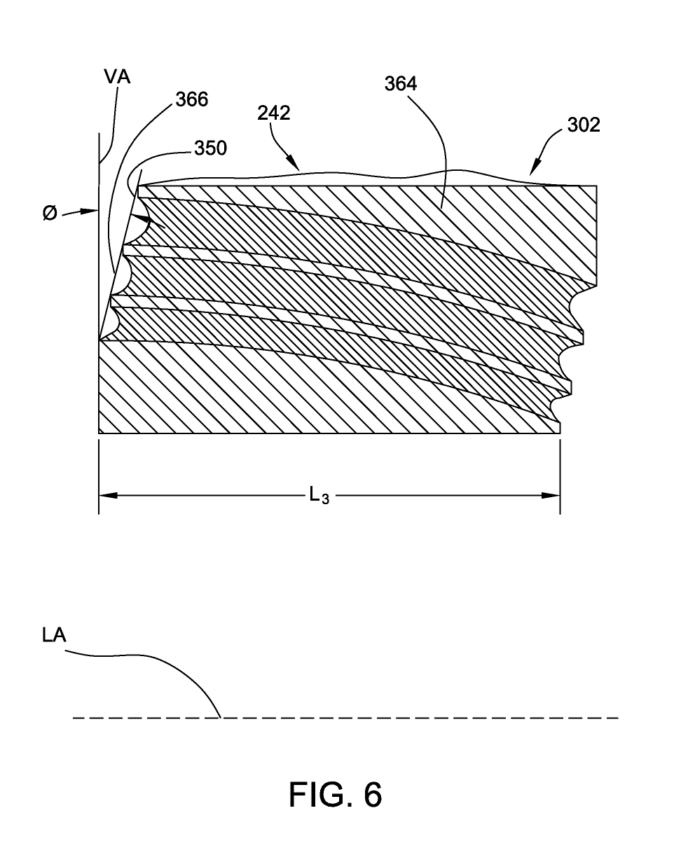

Referring to FIG. 6, a portion 364 of the second subassembly 302 is shown in an unassembled condition and includes a side 366 of the V-shaped circumferential groove 350. The side 366 is disposed at an offset angle ø relative to the vertical axis “VA” and defines a slope of the V-shaped circumferential groove 350. In the illustrated embodiments, the offset angle ø is about 18°. In other embodiments, the offset angle ø can be in a range up to about 45° in some embodiments, in a range between about 5° and about 30° in other embodiments, and in a range between about 10° and about 30° in yet other embodiments. In still other embodiments, the offset angle ø can be varied to generate a desired amount of pre-strain in the elastomeric bearing when the portions of the subassemblies comprising the outer race are driven together. In yet other embodiments, one or both sides 366 of the groove 350 can be curved (e.g., a convex or a concave curve) or have a non-planar shape.

Referring to FIG. 7, to help reduce elastomeric strains at the edges of the elastomeric bushing 242 when undergoing relative rotation as pitch about the transverse axis “TA,” the elastomeric bushing 242 can include a generally spherical segment configuration. The arrangement of the elastomeric layers 391, 392, 393 and the metal plies 397, 398 provides a generally spherical segment which can help reduce stresses and strains in the elastomeric layers 391, 392, 393 generated by relative rotation, such as, as pitch or yaw, by accommodating the rotation through shear in the layers, rather than compression or tension.

Referring to FIG. 4, the first and second subassemblies 301, 302 are substantially similar to each other and are configured as mirror images about the midline plane 307 so that the elastomeric bushing 242 is substantially symmetrical about its midline plane 307, which is perpendicular to the longitudinal axis “LA.” Referring to FIG. 7, the elastomeric layers 391, 392, 393 and the metal plies 397, 398 are generally barrel-shaped. The longitudinal axis “LA” of the elastomeric bushing 242 constitutes an axis of revolution about which the annular arcs 330, 331 are rotated such that the elastomeric bushing 242 is substantially symmetrical about the longitudinal axis “LA” extending centrally through the axial passage 351.

In one embodiment, a method of making an elastomeric bushing 242 for a pin joint assembly 224 includes abutting a first subassembly 301 and a second subassembly 302. An inner end 304 of the first subassembly 301 and an inner end 305 of the second subassembly 302 are abutted in adjoining relationship to each other and define a circumferential groove 350 therebetween. The first subassembly 301 and the second subassembly 302 form an inner race 360 extending along a longitudinal axis “LA,” an outer race 358 coaxially arranged with the inner race 360, a plurality of elastomeric layers 391, 392, 393 disposed between the outer race 358 and the inner race 360 and defining at least one pair of adjacent elastomeric layers 391, 392, 393, and a metal ply 397, 398 interposed between the elastomeric layers 397, 398 of at least one pair of adjacent elastomeric layers. The first subassembly 301 and the second subassembly 302 are moved to axially approach each other along the longitudinal axis “LA” to close the circumferential groove 350 defined between the first subassembly 301 and the second subassembly 302, thereby generating an axial compressive pre-load in at least a portion of one of the elastomeric layers 391, 392, 393. In embodiments, at least a portion of one of the elastomeric layers 391, 392, 393 can be in a pre-compressed state.

In some embodiments of a method of making an elastomeric bearing, the elastomeric layers 391, 392, 393 are adapted to permit relative rotation and translation between the outer race 358 and the inner race 360. In yet other embodiments of a method of making an elastomeric bearing, the first subassembly 301 and the second subassembly 302 each includes a side 366 of the circumferential groove 350. The circumferential groove 350 is substantially-V-shaped. In still other embodiments, each side 366 of the first and the second subassemblies 301, 302 is disposed at an offset angle ø relative to a vertical axis “VA.” The vertical axis “VA” is substantially perpendicular to the longitudinal axis “LA.” The offset angle ø is in a range up to about 30°.

### INDUSTRIAL APPLICABILITY

The industrial applicability of the embodiments of a pin joint provided with an elastomeric bushing described herein will be readily appreciated from the foregoing discussion. The described principles are applicable to machines and equipment including a pivotal linkage arrangement between a pair of members such that one member is rotatably movable with respect to the other member. A pin joint having an elastomeric bushing constructed in accordance with principles of the present disclosure can be used to provide the pivotal linkage. Examples of such machines include compaction machines, including a wheel loader, for example. The pin joint disclosed herein can advantageously be offered on new equipment, or can be used to retrofit existing equipment operating in the field, such as when provided in the form of a cartridge, for example.

In one example, during use, the pin 40 of the pin joint assembly 24 can be held stationary by the first and second collars 44, 45. The elastomeric bushing 42 can rotate about the longitudinal axis “LA” relative to the pin 40 while engaging the first and second sleeve bearings 91, 92. The first and second sleeve bearings 91, 92, in turn, rotate about the longitudinal axis “LA” while engaging the elastomeric bushing 42 and the pin 40. The interposition of the first and second sleeve bearings 91, 92 between the elastomeric bushing 42 and the pin 40 provides two pairs of hardware interfaces, namely a pair of bushing-to-sleeve bearing interfaces and a pair of sleeve bearing-to-pin interfaces. As a result, if any particular hardware interface that enables rotation of the elastomeric bushing 42 should lose lubrication, thereby resulting in full or partial seizing of the interface, the remaining, unseized hardware interfaces can help enable the elastomeric bushing 42 to continue rotating relative to the pin 40. In this way, the various hardware interfaces provide redundancy to help enable the rotation of the elastomeric bushing 42 demanded during routine use of the pin joint assembly 24.

Furthermore, the elastomeric bushing 42 is adapted to allow out-of-plane movement. In some embodiments, the elastomeric bushing 42 allows relative rotational movement between a pivotal member, such as a boom 21, and the frame 11 with at least three degrees of freedom, including roll, pitch, and yaw.

The pin joint assembly 24 endures radial loads during use, as well as axial loads along or in substantially parallel relation to the longitudinal axis “LA.” While the sleeve bearings 91, 92 help the pin joint assembly 24 bear radial loads, the first and second thrust rings 95, 96 help the pin joint assembly 24 bear axial loads. Specifically, during use, the thrust rings 95, 96 slide along the pin 40 and/or compress and decompress in reaction to axial loads, thereby dampening axial loads and, by extension, helping to reduce wear of the pin joint assembly 24 caused by axial loads. The thrust rings 95, 96 reside wholly within the channels 85, 86, respectively, and as a result are better enabled to move as necessary to bring about such dampening. Further, the sleeve bearings 91, 92 extend beyond the elastomeric bushing 42 into the channels 85, 86, respectively, thereby spacing the thrust rings 95, 96 apart from the elastomeric bushing 42 in order to help prevent the rotation of the elastomeric bushing 42 from interfering with the movement and/or compression and decompression of the thrust rings 95, 96 during use of the pin joint assembly 24.

The first and second seal assemblies 51, 52 help prevent lubricant (not shown) from leaking out of the channels 85, 86, respectively. Specifically, the first and second seal rings 111, 112 of each of the seal assemblies 51, 52 rotate against one another in sealing engagement. The load rings 121, 122 of each of the seal assemblies 51, 52 act in the manner of a spring to apply an axial load respectively against the first and second seal rings 111, 112 in opposing directions along the longitudinal axis “LA” to bring the sealing faces 136 of the first and second seal rings 111, 112 of each of the seal assemblies 51, 52 into face-to-face sealing contact under pressure along a band of contact such that a running fluid-tight seal is formed. The structure of each of the seal assemblies 51, 52 maintains the first and second load rings 121, 122 in proximal relationship to the first and second seal rings 111, 112, respectively, to promote the opposing axial forces exerted by the first and second seal rings 111, 112 against each other. Accordingly, lubricant (not shown) can be restrained from escaping the first and second channels 85, 86 and the cavity 74 under difficult loading conditions.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A pin joint assembly comprising:
an elastomeric bushing, the elastomeric bushing defining an axial passage extending therethrough along a longitudinal axis; and
a pin, the pin being disposed in the axial passage of the elastomeric bushing and extending along the longitudinal axis; and
wherein the elastomeric bushing includes:
an inner race extending along the longitudinal axis, the inner race being rotationally movable with respect to the pin about the longitudinal axis,
an outer race coaxially arranged with the inner race,
at least one elastomeric layer disposed between the outer race and the inner race, and
wherein the outer race is pivotably movable with respect to the inner race about at least one axis substantially perpendicular to the longitudinal axis.

2. The pin joint assembly of claim 1, wherein the elastomeric bushing comprises:
a plurality of elastomeric layers disposed between the outer race and the inner race, the plurality of elastomeric layers defining at least one pair of adjacent elastomeric layers, and
a metal ply interposed between the elastomeric layers of at least one pair of adjacent elastomeric layers.

3. The pin joint assembly of claim 2, wherein the plurality of elastomeric layers are adapted to permit relative rotation and translation between the outer race and the inner race, and at least a portion of one of the elastomeric layers is in a pre-compressed state.

4. The pin joint assembly of claim 3, wherein the inner race, the outer race, the plurality of elastomeric layers, and the metal ply are formed from a first subassembly and a second subassembly.

5. The pin joint assembly of claim 2, wherein the outer race and the inner race are pivotably movable with respect to each other about a transverse axis, the transverse axis being substantially perpendicular to the longitudinal axis.

6. The pin joint assembly of claim 5, wherein the outer race and the inner race are pivotably movable with respect to each other about a vertical axis, the vertical axis being substantially perpendicular to the longitudinal axis and the transverse axis.

7. The pin joint assembly of claim 2, wherein the outer race and the inner race are pivotably movable with respect to each other with at least two degrees of freedom.

8. The pin joint assembly of claim 2, wherein the plurality of elastomeric layers are subjected to an axial compressive pre-load.

9. The pin joint assembly of claim 8, wherein the inner race, the outer race, the plurality of elastomeric layers, and the metal ply are formed from a first subassembly and a second subassembly, the first subassembly and the second subassembly each having an inner end, the inner end of the first subassembly and the inner end of the second subassembly being in adjoining relationship to each other and defining a circumferential groove therebetween, the axial compressive pre-load generated by moving the first subassembly and the second subassembly to axially approach each other along the longitudinal axis to close the circumferential groove defined between the first subassembly and the second subassembly.

10. The pin joint assembly of claim 1, further comprising:
a first member and a second member both coaxial with the pin about the longitudinal axis, the first member being pivotable about the longitudinal axis with respect to the second member, the first member including an inner end, the second member including an outer end, the inner end of the first member being in proximal relationship to the outer end of the second member and defining, at least in part, a seal cavity extending axially and interposed between the first member and the second member; and
a seal assembly disposed in the seal cavity between the first member and the second member;
wherein the second member comprises the elastomeric bushing.

11. The pin joint assembly of claim 10, wherein the first member includes a load ring engagement surface, the second member includes a load ring engagement surface, the load ring engagement surface of the first member and the load ring engagement surface of the second member defining, at least in part, the seal cavity, and the seal assembly comprises:
a first annular seal ring and a second annular seal ring, the first annular seal ring and the second annular seal ring each having a loading surface and a sealing face, the first annular seal ring and the second annular seal ring abutting one another such that the sealing face of the first annular seal ring and the sealing face of the second annular seal ring are in contacting relationship with each other, and
a first annular load ring and a second annular load ring, the first annular load ring engaging the load ring engagement surface of the first member and the loading surface of the first annular seal ring, the second load ring engaging the load ring engagement surface of the second member and the loading surface of the second annular seal ring.

12. The pin joint assembly of claim 10, wherein the first member comprises a first collar, the elastomeric bushing having a second outer end, the pin joint assembly further comprising:
a second collar coaxial with the pin such that the elastomeric bushing is disposed between the first collar and the second collar, the second collar including an inner end, the second outer end of the elastomeric bushing and the inner end of the second collar defining, at least in part, a second seal cavity extending axially and interposed between the bushing and the second collar;
a second seal assembly disposed in the second seal cavity;
wherein the first collar and the second collar respectively engage first and second end portions of the pin such that the first collar and the second collar are rotatively coupled with the pin;
wherein the elastomeric bushing is rotatable about the longitudinal axis relative to the pin and the first collar and the second collar;
wherein the first seal assembly and the second seal assembly respectively providing running seals between the elastomeric bushing and the first collar and the elastomeric bushing and the second collar.

13. The pin joint assembly of claim 12, wherein the pin, the elastomeric bushing, the first collar, the second collar, the first seal assembly, and the second seal assembly are provided in a unitary cartridge.

14. The pin joint assembly of claim 1, further comprising:
a sleeve bearing coaxially disposed with respect to the elastomeric bushing and the pin, the sleeve bearing being radially interposed between the elastomeric bushing and the pin, the sleeve bearing being rotatably movable with respect to the pin about the longitudinal axis.

15. The pin joint assembly of claim 14, wherein the sleeve bearing comprises a self-lubricating sleeve bearing.

16. The pin joint assembly of claim 14, wherein the sleeve bearing is secured to the inner race of the elastomeric bushing to prevent relative rotation between the inner race and the sleeve bearing about the longitudinal axis.

17. A machine comprising:
a frame;
a pivotal member; and
a pin joint assembly, the pivotal member pivotally attached to the frame via the pin joint assembly, the pin joint assembly comprising:
an elastomeric bushing, the elastomeric bushing defining an axial passage extending therethrough along a longitudinal axis, the elastomeric bushing being coupled to the pivotal member; and
a pin, the pin being disposed in the axial passage of the elastomeric bushing and extending along the longitudinal axis, the pin being coupled to the frame; and
wherein the elastomeric bushing includes:
an inner race extending along the longitudinal axis, the inner race being rotationally movable with respect to the pin about the longitudinal axis,
an outer race coaxially arranged with the inner race,
at least one elastomeric layer disposed between the outer race and the inner race, and
wherein the outer race is pivotably movable with respect to the inner race about at least one axis substantially perpendicular to the longitudinal axis.
